(19) United States
(12) Patent Application Publication
(10) Pub. No.: US 2009/0176451 A1
(43) Pub. Date: Jul. 9, 2009

(54) ENCODED COLOR INFORMATION FACILITATING DEVICE PAIRING FOR WIRELESS COMMUNICATION

(75) Inventors: Ting-yi Yang, Redmond, WA (US); Thyagarajan Lakshmanan, Redmond, WA (US); Lotfi Herzi, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/106,328

(22) Filed: Apr. 21, 2008

Related U.S. Application Data
(60) Provisional application No. 61/019,226, filed on Jan. 4, 2008.

(51) Int. Cl. H04B 7/00

(52) U.S. Cl. 455/41.2

(57) ABSTRACT

Pairing information is encoded as color information by a color coding device. The encoded color information is displayed by the color coding device and viewed by a color decoding device. The color decoding device decodes the encoded pairing information and uses the decoded pairing information to establish wireless communication with the color coding device.

### CROSS REFERENCE TO RELATED APPLICATIONS

This application claims priority to U.S. Provisional Application No. 61/019,226, filed Jan. 4, 2008, the entirety of which is hereby incorporated herein by reference.

### BACKGROUND

The sharing of data stored on mobile devices, such as cell phones, cameras, and personal digital assistants currently poses various difficulties. For example, currently a mobile device user may share such data by first transferring the data to a computer and then sharing the data by email or by uploading to a network server. However, such sharing processes may take many user steps and may be difficult to perform while a user is away from a home computer.

Some mobile devices, such as cellular phones, may be equipped to send photographs and other such data to other devices over a cellular network. However, per transaction costs may be high for sending such data. Additionally, each transaction may involve multiple user steps. Further, the generally small sizes of mobile device displays may limit the number of persons who can view the data on the receiving device, and therefore may reduce user satisfaction with the sharing experience.

Likewise, some mobile devices equipped with wireless communications technologies such as Bluetooth (IEEE 802.15.1) and WiFi (IEEE 802.11x) may be configured to allow the sharing of data with other similarly-equipped devices. However, sharing content via such technology also may involve many user steps to connect to and transfer content between devices. Eliminating steps to improve the user experience may pose problems where more than one mobile device is detected within communication range, as it may be difficult for each mobile device to identify with which other mobile device to communicate.

### SUMMARY

The use of encoded color information for the purpose of pairing two or more devices for wireless communication is provided. Pairing information is encoded as color information by a color coding device. The encoded color information is displayed by the color coding device and viewed by a color decoding device. The color decoding device decodes the encoded pairing information and uses the decoded pairing information to establish wireless communication with the color coding device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a color coding device according to the present disclosure.

FIG. 2 shows a process flow of a method of pairing two devices for wireless communication.

FIG. 3 shows a schematic diagram of another embodiment of a color coding device.

FIG. 4 shows a schematic diagram of yet another embodiment of a color coding device.

### DETAILED DESCRIPTION

The pairing of two or more devices for wireless communication is disclosed. As a nonlimiting example, information that assists in pairing a surface computing device to a mobile device is encoded as color information by the surface computing device. The encoded color information is displayed by a screen of the surface computing device and viewed by an image detector (e.g., camera) of the mobile device. The mobile device then decodes the viewed color information and uses the decoded information to pair with the surface computing device.

While the pairing of a surface computing device to a mobile device is used as an example, it should be understood that other devices capable of wireless communication can use the same pairing process. This disclosure is applicable to the pairing of virtually any wireless device capable of displaying color information (i.e., color coding device) with virtually any wireless device capable of viewing the displayed color information (i.e., color decoding device).

As described in more detail below, the disclosed pairing process can improve the user experience when sharing data between two wireless devices. For example, several steps that a user may otherwise need to perform if not for the disclosed pairing process can be avoided altogether. Also, neither device need be specially “tagged” in order to successfully pair with one another. Furthermore, the present disclosure provides for two-way identification, so that both devices are able to uniquely identify the other device during the pairing process.

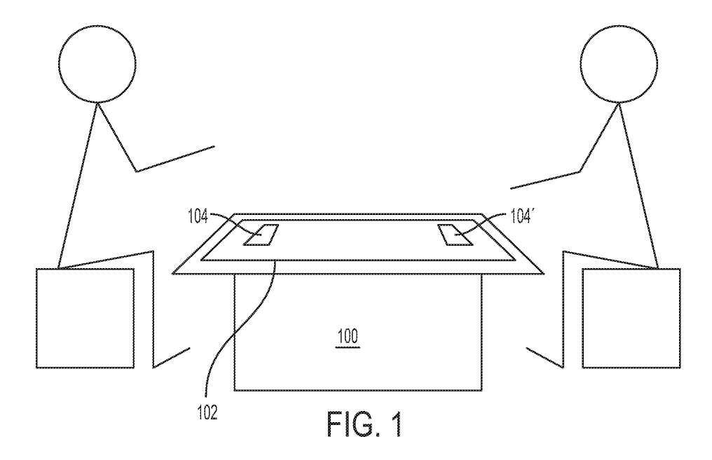

FIG. 1 shows an embodiment of a surface computing device 100 configured to pair with a mobile device. Once paired, the surface computing device may receive data from the mobile device and display, or otherwise present, the data to a plurality of users. Data that may be shared via surface computing device 100 may include, but is not limited to, photographic data, video data, music and other audio data, graphical data, documents, spreadsheets, presentations, and device settings. Surface computing device 100 may also be configured to allow various operations to be performed on displayed data, including but not limited to editing, sending via email, uploading to other mobile devices, printing, and ordering printed copies over a network.

Surface computing device 100 may be configured to receive data from and/or to transfer data to any suitable device. Examples of such devices include, but are not limited to, cellular phones, personal digital assistants, portable media players, cameras, video cameras, and/or other consumer electronics and appliances.

The depicted surface computing device includes a horizontal, table-like, top surface having a touch-sensitive display screen 102. Display screen 102 is capable of presenting visual information to one or more users. As described in more detail below, a surface computing device can code various types of data as color information, and the surface computing device can use its display screen to display the encoded color information. As such, surface computing device 100 is a nonlimiting example of a color coding device.

Display screen 102 is also capable of receiving input from one or more users. For example, the surface computing device can recognize the touch of a user, and can translate the various ways in which a user touches the screen into different commands. The surface computing device can recognize the touch of a user by visually monitoring the display screen with one or more cameras, as described below in more detail. In other embodiments, the display screen may be configured for capacitive touch sensing and/or resistive touch sensing. The disclosed pairing process is not limited by the manner in which the surface computing device recognizes user input.

The following are nonlimiting examples of how the touch of a user can be translated into commands for controlling the surface computing device: touching a single virtual object presented on the display screen may select the virtual object; tracing a path that surrounds two or more virtual objects may select the virtual objects as a group; moving a finger touching a virtual object may drag the virtual object across its virtual environment; moving two fingers away from one another on the display screen may zoom in on a selected virtual object; rotating one finger around another finger on the display screen may rotate a selected virtual object. Additional or alternative ways of touching display screen 102 can be translated into additional or alternative user commands.

Surface computing device 100 may also be configured to recognize when an object other than the finger of a user touches display screen 102.

FIG. 1 schematically shows a first mobile device 104 resting on display screen 102. The surface computing device may be configured to recognize the mobile device on the display screen. Furthermore, the mobile device may be configured to view encoded color information that is displayed by display screen 102 and decode the encoded color information. As such, mobile device 104 is a nonlimiting example of a color decoding device.

There are several different usage scenarios in which it may be advantageous for surface computing device 100 to wirelessly communicate with a mobile device that is resting on display screen 102. For example, a user may wish to wirelessly transfer digital photographs stored on the mobile device to the surface computing device when the mobile device is placed on the surface computing device. As another example, a user may wish to wirelessly transfer a map from the surface computing device to the mobile device when the mobile device is placed on the surface computing device. It should be understood that a virtually limitless number of different usage scenarios exist in which wireless communication between the surface computing device and the mobile device is beneficial.

The surface computing device and the mobile device may establish a wireless connection in order to transfer various types of data. The wireless connection can adhere to one or more different protocols, including, but not limited to, Bluetooth and WiFi. The surface computing device and the mobile device may each include a wireless communication system that facilitates radio-frequency communication between the devices. As part of establishing a wireless connection across which data may be transferred, the surface computing device and the mobile device may first pair with one another.

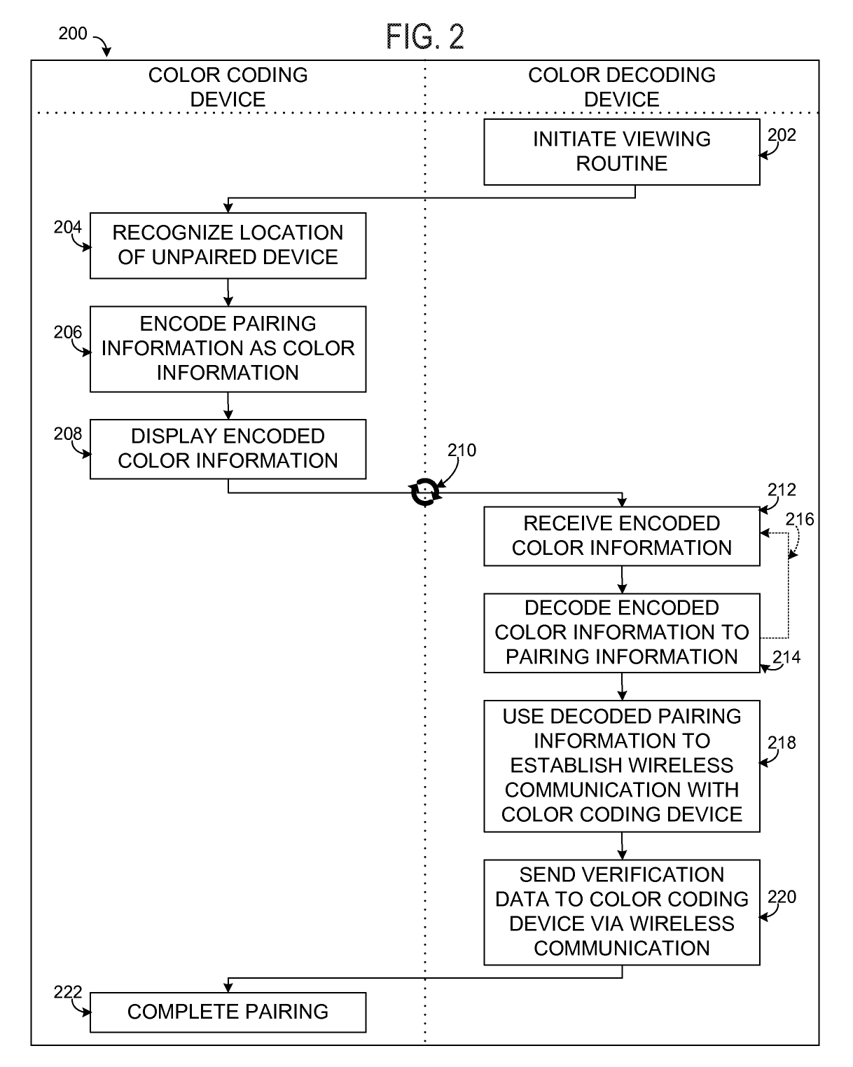

FIG. 2 shows a process flow depicting a method for pairing two devices together. Method 200 can be used to pair a color coding device with a color decoding device. Surface computing device 100 is a nonlimiting example of a color coding device, and mobile device 104 is a nonlimiting example of a color decoding device. However, it should be understood that method 200 can be used to pair devices other than surface computing devices with mobile devices.

The process flow of method 200 is arranged so that actions performed by the color coding device (e.g., surface computing device) are indicated in the left hand column, and actions performed by the color decoding device (e.g., mobile device) are indicated in the right hand column.

Method 200 includes, at 202, initiating a viewing routine on the color coding device. As a nonlimiting example, a client application of mobile device 104 can be launched, and the client application can instruct the mobile device to use a camera or other image sensor to look for encoded color information. Such a client application can be manually launched by a user. In some embodiments, a client application can be automatically launched without user intervention, although this is not required. Providing the user with the choice to launch the client application can improve security and/or decrease energy usage, because the mobile device need not constantly monitor for a beacon instructing it to launch the client application.

In several usage scenarios, the color decoding device is placed on, or in close proximity to, the color coding device (as shown in FIG. 1). It should be understood that in such scenarios, the viewing routine can be initiated before the color decoding device is placed on, or in close proximity to, the color coding device. When the color coding device is a surface computing device and the color decoding device is a mobile device with a built-in camera, the mobile device can be placed on the surface computing device so that the built-in camera is aimed for viewing the display screen of the surface computing device.

In some embodiments, a surface computing device may include one or more landing pads—areas that are configured to receive a mobile device. Such landing pads may be a subsection of the main display screen, or an area other than the main display screen. In other embodiments, a mobile device may be placed on any portion of the display screen.

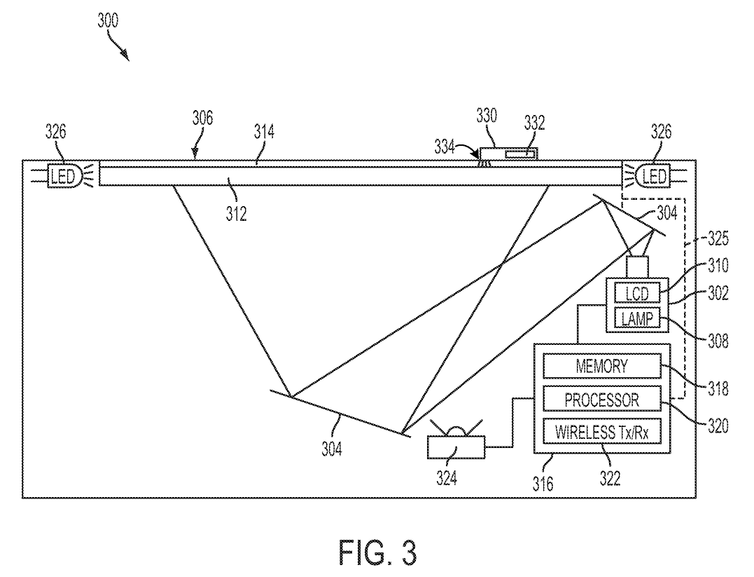

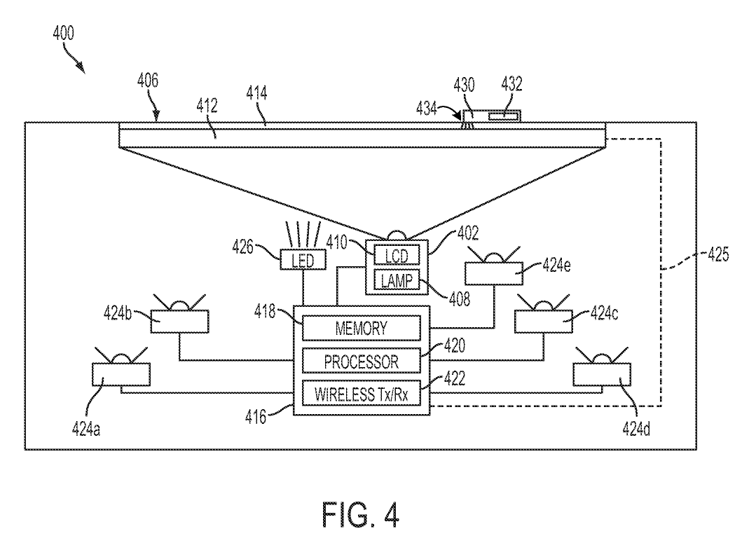

At 204, the color coding device recognizes the location of the unpaired device. For example, if mobile device 104 is placed on display screen 102 of surface computing device 100, the surface computing device can determine the physical location of the mobile device. As a nonlimiting example, a surface computing device that uses a vision system, as described below with reference to FIGS. 3 and 4, may determine the boundary of the unknown object from captured raw image data. For example, the boundary of the unknown object, as recognized in the raw image data, can be defined as a series of [x, y] coordinates. As another example, the unknown object can be assigned a single [x, y] coordinate corresponding to a location interior its boundary.

At 206, the color coding device encodes pairing information as color information. The encoded pairing information can include virtually anything that can facilitate wireless communication with the device to which the color coding device is to be paired. Pairing information that can be coded includes, but is not limited to, the wireless address of the color coding device, the device number assigned to the color decoding device, the physical location of the unknown object suspected to be the color decoding device, checksum and/or other error correction information, and validation information.

The pairing information can be encoded as color information in a variety of different manners. For example, the pairing information can be represented as a binary sequence of 1s and 0s. A specific color (e.g., red) can be assigned to the 1s and a different color (e.g., blue) can be assigned to the 0s. The colors used to encode the pairing information can be selected based on a variety of different factors—e.g., the ease in which one selected color can be differentiated from another selected color, and the probability that a selected color will not be masked by a similar color occurring in ambient conditions. While disclosed herein in the context of the representation of bits via red and blue colors, it will be understood that any other suitable colors may be used, including but not limited to black, white, and grayscale shades.

As can be appreciated from the above description, pairing information can be represented as a base-2 (binary) number, and the base-2 number can be encoded as a sequence comprising occurrences of two different colors (e.g., red and blue, or any other two colors that can be differentiated by a receiving camera or light detector). In some embodiments, the pairing information can be represented and encoded using a different number system and a different number of colors. For example, the pairing information may be encoded using a base-8 number system, in which case the pairing information could be encoded as a sequence comprising occurrences of eight different distinguishable colors. The pairing information can be encoded with a number system having a radix as large as the number of different colors the color coding device can reproduce and/or the color decoding device can uniquely identify.

The variety of different types of pairing information to be encoded can optionally be parsed into the desired number system and concatenated together. As an example, a header can be represented as a first binary number, a Bluetooth address for the color coding device can be represented as a second binary number, a Bluetooth device number assigned to the color decoding device can be represented as a third binary number, the physical location of the unknown object suspected to be the color decoding device can be represented as a fourth binary number, and all such numbers can be concatenated together. To limit data corruption, one or more checksum bits can be inserted at configurable intervals. Such a checksum bit can be encoded using one of the colors selected to code the other pairing information, or one or more different checksum colors can be used. Similarly, different colors can be used as indicators for other purposes, such as signaling the beginning or end of an encoded sequence.

At 208, the color coding device displays the encoded color information. For example, surface computing device 100 can flash the encoded sequence of colors at a configurable frequency. The frequency and duty cycle of each flash of color can be universally selected for compatibility with a variety of different color decoding devices. In particular, the frequency and duty cycle can be selected to fall within the viewing and analyzing capabilities of the types of devices with which the color coding device will likely be paired.

In embodiments in which the color coding device is able to determine the type of the targeted color decoding device, the color coding device can customize the frequency and/or duty cycle of the color flashes based on the viewing and analyzing capabilities of the targeted color decoding device. The color coding device may determine the type of the targeted color coding device by analyzing its shape, or by any other suitable method.

Surface computing device 100 may be configured to flash the coded color information using the entirety of display screen 102. Alternatively, the surface computing device may be configured to flash the coded color information using less than the entire display screen. In embodiments in which the surface computing device includes a landing pad onto which the mobile device is to be placed, the color may be flashed only at the landing pad. In embodiments in which the mobile device can be placed anywhere on the display screen, the color may be flashed only at the location at which the mobile device is actually placed.

As indicated at 210, the color coding device may repeatedly display the encoded color information. The color information can be repeatedly displayed for a predetermined number of cycles, for a predetermined duration, until the color coding device receives a response from the color decoding device, or until the color coding device receives a command to stop displaying the encoded color information.

At 212, the color coding device receives the encoded color information. As a nonlimiting example, a mobile device 104 in the form of a cellular phone may be placed on display screen 102 such that the built-in camera of the mobile device is aimed for viewing display screen 102. As the display screen flashes the encoded color sequence, the built-in camera captures the flashes. As mentioned above, the frequency and duty cycle of the flashes can be selected so that the built-in camera and associated processing system can keep up with the sequence of color flashes.

The color decoding device can use a tool other than a camera for receiving encoded color information in some embodiments. For example, some embodiments may include a light sensor that is capable of differentiating colors, but which is not capable of forming a multi-pixel image.

At 214, the encoded color information is decoded by the color decoding device into the pairing information. In other words, after the decoding device receives the encoded color information, it undoes the encoding that was performed by the color coding device. In this manner, the pairing information is optically transmitted from the color coding device to the color decoding device.

In some embodiments, the decoding process may include a verification of data integrity. As a nonlimiting example, a checksum analysis may be performed to ensure that all data is successfully transmitted. If an error is detected, the color decoding device can again attempt to receive the encoded color information, as indicated at 216.

At 218, the color decoding device uses the decoded pairing information to establish wireless communication with the color coding device. This may be accomplished in a variety of different manners depending on the particular type of wireless technology that is used. In some embodiments, the color decoding device will use a transmitted wireless address of the color coding device to initiate a wireless handshake with the color coding device. The color decoding device may also wirelessly announce the device number that it was assigned by the color coding device.

At 220, the color decoding device sends verification data to the color coding device. The color coding device can use the verification data to uniquely identify one color decoding device from another color decoding device.

Verification data can include, but is not limited to, the physical location of the color decoding device. For example, mobile device 104 may receive color information defining the physical location at which surface computing device 100 believes the mobile device is resting. The mobile device can return this location information to the surface computing device over the wireless communication channel, so that the surface computing device can verify that it is wirelessly communicating with the mobile device with which it thinks it is communicating.

Data other than location information can be used as a verification. The surface computing device can display encoded verification data (e.g., a passkey) in the form of color information. Such color information can be display at a limited area corresponding to the detected location of an object that the surface computing device suspects is a mobile device to which wireless communication is to be established. Accordingly, the surface computing device can verify that a device that is wirelessly communicating with the surface computing device is the intended device if that device successfully wirelessly transmits the verification data back to the surface computing device.

The surface computing device can verify the location of a mobile device placed on display screen 102 by using a verification technique as described above. This may be particularly useful when two or more different mobile devices are placed on display screen 102. For example, FIG. 1 shows a second mobile device 104′ on display screen 102. Surface computing device 100 can differentiate mobile device 104 from mobile device 104′ by displaying different encoded verification data in the form of color information to the different mobile devices. The surface computing device can tell which mobile device is establishing wireless communication by analyzing which verification data that mobile device is sending to the surface computing device.

At 222, the color coding device completes the pairing. Once wireless communication is established, the paired devices may transmit virtually any type of data to one another. Furthermore, the color coding device knows the physical location of the color decoding device, and the color coding device can use this knowledge to enhance a user's experience. For example, surface computing device 100 can download a collection of digital photographs from mobile device 104 over the wireless communication channel. Once downloaded, the surface computing device can display the digital photographs in an area on display screen 102 that is surrounding mobile device 104. Further, the digital photographs can be presented in a manner that reinforces their origin, such as by expanding the size of the digital photographs from thumbnails to full-size images as the digital photographs fan out from “under” the mobile device.

If a paired mobile device is moved to a different location on the display screen, the surface computing device can track the movement so as to maintain knowledge of the location of the mobile device. Additionally or alternatively, the surface computing device can perform a subsequent verification procedure in which the surface computing device displays verification data as color information, and the mobile device returns the verification data to the surface computing device over the wireless communication channel.

As discussed above, a variety of different devices can serve as a color coding device in accordance with the present disclosure. A surface computing device is a nonlimiting example of such a device. FIGS. 3 and 4 show nonlimiting examples of surface computing devices capable of encoding pairing information as color information in accordance with the present disclosure.

FIG. 3 shows a schematic depiction of an embodiment of a surface computing device 300 utilizing an optical touch sensing mechanism. Surface computing device 300 comprises a rear projection display system having an image source 302, optionally one or more mirrors 304 for increasing an optical path length and image size of the projection display, and a display screen 306 onto which images are projected.

Image source 302 includes an optical or light source 308 such as the depicted lamp, an LED array, or other suitable light source. Image source 302 also includes an image-producing element 310 such as the depicted LCD (liquid crystal display), an LCOS (liquid crystal on silicon) display, a DLP (digital light processing) display, or any other suitable image-producing element. Display screen 306 includes a horizontally orientated clear, transparent portion 312, such as a sheet of glass, and a horizontally orientated diffuser screen layer 314 disposed on top of the clear, transparent portion 312. In some embodiments, an additional transparent layer (not shown) may be disposed over diffuser screen layer 314 to provide a smooth look and feel to the display surface.

Continuing with FIG. 3, surface computing device 300 further includes an electronic controller 316 comprising computer readable memory 318 and a processor 320. The memory may include instructions, that when executed by the processor, cause the surface computing device to execute the above described color coding and pairing.

Further, controller 316 may include a wireless transmitter and receiver 322 configured to conduct two-way communication with mobile devices. Wireless transmitter and receiver 322 may be configured to conduct wireless communications with mobile device in any suitable manner, including but not limited to via 802.11x, Bluetooth, RFID or other radiofrequency communications technologies. While shown as part of controller 316, it will be appreciated that wireless transmitter and receiver 322 may also be provided as a separate device in electrical communication with controller 316.

To sense objects placed on display screen 306, surface computing device 300 includes an image capture device 324 configured to capture an image of the entire backside of display screen 306, and to provide the image to electronic controller 316 for the detection of objects appearing in the image. Diffuser screen layer 314 helps to avoid the imaging of objects that are not in contact with or positioned within a few millimeters of display screen 306, and therefore helps to ensure that only objects that are touching display screen 306 are detected by image capture device 324.

Image capture device 324 may include any suitable image sensing mechanism. Examples of suitable image sensing mechanisms include but are not limited to CCD and CMOS image sensors. Further, the image sensing mechanisms may capture images of display screen 306 at a sufficient frequency to detect motion of an object across display screen 306. Display screen 306 may alternatively or further include an optional capacitive, resistive or other electromagnetic touch-sensing mechanism, as illustrated by dashed-line connection 325 of screen 306 with controller 316.

Image capture device 324 may be configured to detect reflected or emitted energy of any suitable wavelength, including but not limited to infrared and visible wavelengths. To assist in detecting objects placed on display screen 306, image capture device 324 may further include an additional optical source or emitter such as one or more light emitting diodes (LEDs) 326 configured to produce infrared or visible light. Light from LEDs 326 may be reflected by objects placed on display screen 306 and then detected by image capture device 324. The use of infrared LEDs as opposed to visible LEDs may help to avoid washing out the appearance of projected images on display screen 306.

LEDs 326 may be positioned at any suitable location within surface computing device 300. In the depicted embodiment, a plurality of LEDs 326 are placed along a side of display screen 306. In this location, light from the LEDs can travel through display screen 306 via internal reflection, while some can escape from display screen 306 for reflection by an object on the display screen 306. In alternative embodiments, one or more LEDs may be placed beneath display screen 306 so as to pass emitted light through display screen 306.

FIG. 3 also depicts a mobile device 330 that has been placed on display screen 306. Mobile device 330 includes a wireless transmitter and receiver 332 configured to communicate with wireless transmitter and receiver 322 on surface computing device 300. Mobile device 330 also includes an optical detector 334, which can be used to receive encoded color information displayed by display screen 306. Mobile device 330 may include computer readable memory including instructions, that when executed by a processor, cause the mobile device to execute the above described color decoding an pairing.

FIG. 4 shows a schematic depiction of another embodiment of a surface computing device 400 that utilizes an optical touch sensing mechanism. Surface computing device 400 comprises a projection display system having a wide angle image source 402 and a display screen 406 onto which images are projected. Image source 402 includes a light source 408 and an image-producing element 410. Display screen 406 includes a transparent glass structure 412 and a diffuser screen layer 414 disposed thereon.

Continuing with FIG. 4, surface computing device 400 includes an electronic controller 416 comprising memory 418 and a processor 420. Further, surface computing device 400 includes a wireless transmitter and receiver 422 configured to conduct two-way communication with mobile devices, such as device 430 via wireless transmitter and receiver 432 on device 430. It is noted that mobile device 430 also includes an optical detector 434, which can be used to receive encoded color information displayed by display screen 406.

Surface computing device further includes a plurality of image capture devices, depicted as 424a-424e, and an optical emitter such as an LED array 426 configured to illuminate a backside of display screen 406 with infrared or visible light. Image capture devices 424a-424e are each configured to capture an image of a portion of display screen 406 and provide the image to controller 416, and to assemble a composite image of the entire display screen 406 from the images. In the depicted embodiment, image capture devices 424a-424d are positioned generally beneath the corners of display screen 406, while image capture device 424e is positioned in a location such that it does not pick up glare from LED array 426 reflected by display screen 406 that may be picked up by image capture devices 424a-424d. In this manner, images from image capture devices 424a-424e may be combined by controller 416 to produce a complete, glare-free image of the backside of display screen 406. This allows detection of an object such as a mobile device 430 placed on display screen 406. Display screen 406 may alternatively or further include an optional capacitive, resistive or other electromagnetic touch-sensing mechanism, as illustrated by dashed-line connection 425 of screen 406 with controller 416.

It will be appreciated that the configurations and/or approaches described herein are exemplary in nature, and that these specific embodiments or examples are not to be considered in a limiting sense, because numerous variations are possible. For example, while described herein in the context of a surface computing device having a horizontal, table-like display surface, it will be appreciated that the concepts described herein may also be used with displays of any other suitable orientation, including vertically arranged displays.

Furthermore, the specific routines or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the exemplary embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A method of pairing a color coding device with a color decoding device for wireless communication, comprising:
encoding pairing information as color information with the color coding device;
displaying the color information with the color coding device;
receiving the color information with the color decoding device;
decoding the color information into decoded pairing information with the color decoding device; and
establishing wireless communication between the color coding device and the color decoding device using the decoded pairing information.

2. The method of claim 1, where the color information includes a sequence of distinguishable colors.

3. The method of claim 2, where the sequence of distinguishable colors are mapped to a binary number such that a first distinguishable color is used to represent a 1 and a second distinguishable color is used to represent a 0.

4. The method of claim 1, further comprising recognizing a location of an unpaired device with the color coding device, encoding the location as color information with the color coding device, and displaying the color information corresponding to the location.

5. The method of claim 4, further comprising decoding the color information corresponding to the location with the color decoding device, and using the location to verify an identity of the color decoding device to the color coding device.

6. The method of claim 1, where the color coding device is a surface computing device.

7. The method of claim 1, where the color decoding device is a mobile device having a camera.

8. The method of claim 1, where the color decoding device is a mobile device having an image sensor.

9. A color coding device, comprising:
a display capable of presenting two or more distinguishable colors to a color decoding device;
a wireless communication system to wirelessly communicate with the color decoding device;
a processor; and
a computer readable memory including instructions, that when executed by the processor:
cause the processor to encode pairing information as color information;
cause the display to present color information for viewing by the color decoding device;
cause the wireless communication system to receive verification data from the color decoding device, the verification data derived from the pairing information displayed as color information; and
cause the wireless communication system to establish wireless communication with the color decoding device.

10. The color coding device of claim 9, where the computer readable memory includes instructions, that when executed by the processor, cause the processor to encode pairing information as color information that includes a sequence of distinguishable colors.

11. The color coding device of claim 10, where the computer readable memory includes instructions, that when executed by the processor, cause the processor to map the sequence of distinguishable colors to a binary number such that a first distinguishable color is used to represent a 1 and a second distinguishable color is used to represent a 0.

12. The color coding device of claim 9, further comprising an input system configured to recognize a location of an unpaired device, and where the computer readable memory includes instructions, that when executed by the processor, cause the processor to encode the location as color information, and cause the display to display the color information corresponding to the location.

13. The color coding device of claim 12, wherein the input system includes at least one infrared reference light and at least one infrared camera.

14. The color coding device of claim 9, where the display is a rear projection display.

15. The color coding device of claim 14, where the display includes a horizontally orientated diffuser screen onto which projection light is rear projected.

16. The color coding device of claim 9, where the wireless communication system is configured to send and receive data via radio-frequency communication.

17. A computer readable memory comprising instructions, that when executed by a processor, cause a color decoding device to:
view a sequence of distinguishable colors presented by a color coding device;
decode the sequence of distinguishable colors into decoded pairing information; and
utilize the decoded pairing information to establishing radio-frequency communication with the color coding device.

18. The computer readable memory of claim 17, where the instructions cause the color decoding device to decode the sequence of distinguishable colors into decoded pairing information at least in part by translating the sequence of distinguishable colors into a binary number.

19. The computer readable memory of claim 17, where the instructions cause the color decoding device to transmit verification data to the color coding device via radio-frequency communication, the verification data derived from the decoded pairing information.

20. The computer readable memory of claim 19, where the instructions cause the color decoding device to transmit verification data including a physical location of the color decoding device derived from the decoded pairing information.
